(19) United States
(12) Patent Application Publication
(10) Pub. No.: US 2017/0057104 A1
(43) Pub. Date: Mar. 2, 2017

(54) HAIR CLIPPING DEVICE

(71) Applicant: KONINKLIJKE PHILIPS N.V., EINDHOVEN (NL)

(72) Inventor: MARTIJN FRANS JOHAN NAB, EINDHOVEN (NL)

(21) Appl. No.: 15/118,511

(22) PCT Filed: Mar. 24, 2015
(86) PCT No.: PCT/EP2015/056167

§ 371 Date: Aug. 12, 2016

(30) Foreign Application Priority Data
Mar. 31, 2014 (EP) 14162543.4

(51) Int. Cl. B26B 19/20; B26B 19/38

(52) U.S. Cl. CPC B26B 19/20; B26B 19/3813

(57) ABSTRACT

The present invention relates to a hair clipping device (10) comprising: a housing (14), a cutting assembly (16) which is arranged on a distal end (18) of said housing (14) and comprises a stationary cutting blade (22) with a stationary cutting edge (26) and a moveable cutting blade (24) with a moveable cutting edge (28), and a comb attachment (12) which is attachable to the housing (14), wherein the comb attachment (12) comprises a first comb element (34) that is configured to be arranged on a front side (36) of the housing (14) and configured to cover the stationary and the moveable cutting edge (26, 28), wherein said front side (36) runs transverse to the distal end (18) and the cutting assembly (16); wherein the first comb element (34) comprises a plurality of first comb ribs (38) running parallel to each other and parallel to a longitudinal direction (46) of the first comb element (34), wherein a gap size (42), which is defined as distance between two of the first comb ribs (38) measured in lateral direction (44) perpendicular to the longitudinal direction (40), is smaller than 1 mm, and wherein a pitch size (48), which is defined as a sum of the gap size (42) and a width (46) of one of the first comb ribs (38) measured in the lateral direction (44), is smaller than 2 mm.

### FIELD OF THE INVENTION

The present invention relates to a hair clipping device, in particular to a hair clipping device with a comb attachment that is attachable to the housing of the hair clipping device. The present invention further relates to the comb attachment itself.

### BACKGROUND OF THE INVENTION

Electric hair cutting appliances are generally known and include trimmers, clippers and shavers, whether powered by main supplied electricity or batteries. Such devices are generally used to trim body hair, in particular facial and head hair to allow a person to have a well-groomed appearance.

Commonly, conventional devices for cutting hair comprise a main body forming an elongate housing having a front or cutting end (herein referred to as distal end) and an opposing handle end. A cutting assembly is disposed at the distal end. The cutting assembly usually comprises a stationary cutting blade with a stationary cutting edge and a moveable cutting blade with a moveable cutting edge. The moveable cutting blade moves in a reciprocal manner against the stationary cutting blade. The cutting assembly is usually fixed in a single position relative to the housing of the hair clipper, such that the orientation of the cutting assembly is determined by a user orientating the housing or main body of the hair clipping device. The stationary cutting edge and the moveable cutting edge are arranged at the tip portions of the stationary cutting blade and the moveable cutting blade, respectively. These cutting edges usually jut out of the front side of the hair clipper housing, such that the cutting edges are always visible to the user. This makes it easier for the user to see where exactly the hairs are cut, which is specifically advantageous when using the hair clipping device to form and create fine hair contours.

Since there is a great user demand for hair clipping devices that offer the possibility to be used for different hair cut lengths, many known hair clipping devices make use of separate, differently sized comb attachments. These comb attachments are generally mounted on the distal end of the hair clipping device to position the cutting assembly relative to the skin. In other words, such a comb attachment is used as a guide that moves over the skin and guides hair towards the cutting assembly. Typically, the comb attachment is mounted over the cutting assembly and spaces the cutting blades, in particular their cutting edges (the stationary cutting edge and the moveable cutting edge), apart from the surface of the skin from which the hairs extend. However, always having to replace the comb attachment by a different one when the hair cut length shall be changed might be cumbersome for the user, as this is not only time-consuming, but the user also has to store a plurality of differently sized comb attachments.

Therefore, a lot of prior art hair clipping devices use only one comb attachment that is adjustable in different positions relative to the housing of the hair clipping device. Users may thus shift the comb attachment between different positions leading to different hair cut lengths. Usually these moveable comb attachments may be adjusted between hair cut lengths of 3 mm, 5 mm, 7 mm, 9 mm, usually up to 10 mm.

When using the hair clipping device in combination with a comb attachment a plurality of problems may occur. One problem is that the comb attachment may reduce the visibility of the cutting assembly. This often makes it more difficult for the user to observe the position of the stationary and the moveable cutting edge and to see where exactly the hairs are cut. The comb attachment also impairs the reachability of the hairs to be cut, since the comb ribs usually cover the cutting edges and are during use therefore placed in between the user's skin and the cutting assembly. A further challenge when using a hair clipping device with a comb attachment is to guarantee an effective hair lifting. Especially when cutting stiff and/or curled hairs it is sometimes difficult that the hairs are actively caught and lifted so that these hairs may reach the cutting assembly and are cut. Most of the known comb attachments only function as distance elements for adapting the hair cut length, but do not provide an active hair manipulation to lift up the hairs from their natural orientation and thereby increase the probability that especially stiff and curled hairs are actively caught and reach the cutting edges as intended. Due to this, many strokes might be necessary before all hairs are lifted effectively by the ribs of the comb attachment.

Patent application document EP 2105267 A1 discloses a hair clipper having an attachable comb unit. The comb-shaped blade unit of this hair clipper is arranged in a front longitudinal end portion of its body portion. The comb unit includes a first comb portion having a plurality of hair strand passages through which to pass hair strands to be clipped. The first comb portion is arranged to cover a front longitudinal side of the body portion when the first comb portion is in an in-use position.

Patent application document US 2011/0016723 A1 discloses a hair trimmer comprising a fixed cutting element having teeth on the front side thereof, a mobile cutting element which has teeth on the front side thereof and is oscillable in relation to the fixed cutting element. In order to reduce the risk that skin is caught between the teeth or the teeth can penetrate into skin openings such as capillary ducts, leading to painful skin injuries, a protective support is provided which has teeth on its front side, and is arranged on the fixed cutting element, and used to place the hair trimmer on the skin of the user.

A further generic issue in most hair clipping devices is the well-known effect of hair spilling. Since the cut hairs are usually not collected, the use of such hair clipping devices usually leaves a big mess of randomly distributed and spilled cut hairs behind. Reducing this random dispersal of cut hairs both in amount and spread would be appreciated by many users. It would thus be advantageous to reduce the amount of cut hairs randomly flying out of the system.

There is thus still room for improvement.

### SUMMARY OF THE INVENTION

It is an object of the present invention to provide a hair clipping device and a comb attachment for such a hair clipping device which overcome the above-mentioned problems. In particular, it is an object to provide an improved hair clipping device with a comb attachment that ensures reachability and visibility of the cutting assembly, improves hair catching and lifting, and at the same time prevents or at least reduces the random dispersal of cut hairs flying out of the system.

According to a first aspect of the present invention, this problem is solved by a hair clipping device comprising:
a housing,
a cutting assembly which is arranged on a distal end of said housing and comprises a stationary cutting blade with a stationary cutting edge and a moveable cutting blade with a moveable cutting edge, and
a comb attachment which is attachable to the housing,
wherein the comb attachment comprises a first comb element that is configured to be arranged on a front side of the housing and configured to cover the stationary and the moveable cutting edge, wherein said front side runs transverse to the distal end and the cutting assembly;
wherein the first comb element comprises a plurality of first comb ribs running parallel to each other and parallel to a longitudinal direction of the first comb element, wherein a gap size, which is defined as distance between two of the first comb ribs measured in lateral direction perpendicular to the longitudinal direction, is smaller than 1 mm, and wherein a pitch size, which is defined as a sum of the gap size and a width of one of the first comb ribs measured in the lateral direction, is smaller than 2 mm.

According to a second aspect of the present invention, a comb attachment for attachment to a hair clipping device having a housing and a cutting assembly which is arranged on a distal end of said housing and comprises a stationary cutting blade with a stationary cutting edge and a moveable cutting blade with a moveable cutting edge is presented. The comb attachment comprises a first comb element that is configured to be arranged on a front of the housing and configured to cover the stationary and the moveable cutting edge. The mentioned front side runs transverse to the distal end and the cutting assembly. The first comb element comprises a plurality of first comb ribs running parallel to each other and parallel to a longitudinal direction of the first comb element. A gap size, which is defined as distance between two of the first comb ribs measured in lateral direction perpendicular to the longitudinal direction, is smaller than 1 mm. The pitch size, which is defined as a sum of the gap size and a width of one of the first comb ribs measured in lateral direction, is smaller than 2 mm.

In other words, this second aspect of the present invention relates to acomb attachment for attachment to a hair clipping device, which hair clipping device is, during use, to be moved in a moving direction over a skin for clipping hairs present on said skin with a cutting assembly. This comb attachment comprises a first comb element, this first comb element comprises a plurality of first comb ribs running parallel to each other and parallel to a longitudinal direction of the first comb element. A gap size, which is defined as distance between two of the first comb ribs measured in lateral direction perpendicular to the longitudinal direction, is smaller than 1 mm, and a pitch size, which is defined as a sum of the gap size and a width of one of the first comb ribs measured in the lateral direction, is smaller than 2 mm. The comb attachment according to this second aspect of the present invention is configured to be arranged to a front side of a housing of the hair clipping device. Further, when the comb attachment is attached to the hair clipping device, the longitudinal direction of the first comb element is arranged to be oriented away from the skin during use and the first comb element is preceding the hair clipper cutting assembly.

Preferred embodiments of the invention are defined in the dependent claims. It shall be understood that the claimed comb attachment has similar and/or identical preferred embodiments as the claimed hair clipping device and as defined in the dependent claims.

The herein presented comb attachment has, compared to known comb attachments of the prior art, a comb element with a very fine-pitched structure. Said fine-pitched first comb element is arranged on the front side of the housing which runs transverse to the distal end, i.e. transverse to the underside of the cutting assembly, wherein said underside denotes the side of the stationary cutting blade which faces away from the moveable cutting blade. The term “transverse” is herein to be understood as “non-parallel” and not necessarily as “perpendicular”.

It is to be noted that the claimed dimensions for the gap size and the pitch size that are characteristic for the fine-pitched first comb element may not be simply seen as arbitrary design choices, but result from concrete experiments of the applicant. The comb ribs of the first comb element have, compared to “regular” comb attachments, a much smaller width and are arranged much closer to each other. This also results in the fact that the overall number of comb ribs of the first comb element is increased compared to “regular” comb attachments. Usual comb attachments normally have 5 up to 10 comb ribs with a comparatively large gap size in between them. The presented first comb element may have 20 up to 30 comb ribs running parallel to each other and having a comparatively small gap size in between them.

It has been shown that a first comb element building the front section of a comb attachment for a hair clipping device and having a gap size of less than 1 mm and a pitch size of less than 2 mm provides several advantages: Such a fine-pitched comb structure enforces that hairs are better caught and forced to be lifted up more effectively into the cutting assembly. The fact that the comb ribs are closely spaced will increase the probability that hairs are actively caught and lifted, which is especially important for curled and stiff hairs that need an active manipulation to lift up the hairs from their natural orientation. The fine-pitched comb structure therefore results in an improved hair cutting performance and may reduce the number of necessary strokes before all hairs are lifted effectively by the first comb element and cut by the cutting assembly.

A further advantage is that the fine-pitched grating structure of the first comb element prevents many hairs from flying out of the system after being cut. A mess which usually results from an uncontrolled dispersal of cut hairs may thus be prevented with the herein presented comb attachment.

It shall be also noted that the reduction of the gap size and pitch size as taught herein for the newly presented comb element has not at all been obvious. Prior art comb attachments rather focused on comb elements with only a few comb ribs that have a comparatively large width and relatively large gaps in between them, since most of the prior art comb attachments intended to prevent an unwanted clogging effect that may result from hairs getting caught in between the comb attachment and the cutting assembly. Apart from that, thicker comb ribs with larger gaps in between them where thought to be more skin friendly and mechanically more stable.

However, experiments of the applicant have shown that even though comb ribs with a very small width may lead to an acceptable skin comfort, since the overall number of the comb ribs is increased and the gaps in between them are relatively small, such that the herein presented first comb element does not feel uncomfortable. The comb ribs are apart from that more flexible compared to comb ribs of prior art comb attachments. This has also shown to be advantageous with respect to the user comfort.

According to an embodiment, the gap size is larger than 0.2 mm and smaller than 0.8 mm. Even more preferably is a gap size between 0.3 mm and 0.6 mm. The chosen lower limit especially results from the fact that hairs may have a diameter of up to 0.2 mm.

According to a further embodiment, the pitch size is chosen to be larger than 0.7 mm and smaller than 1.7 mm. It is to be noted that the herein mentioned gap sizes and pitch sizes preferably refer to the sizes of all and between all first comb ribs, i.e. not only of a single one. The aforementioned pitch size of between 0.7 mm and 1.7 mm guarantees an even distribution of the hairs, no scratching of the skin, and therefore results in no or only a few skin irritation.

According to a further embodiment, the width of the first comb ribs is larger than 0.5 mm and smaller than 1 mm. Such a small width of the comb ribs guarantees a fairly good visibility of the cutting assembly.

According to a further embodiment, a height of the first comb ribs measured perpendicular to the lateral and the longitudinal direction is larger than 1 mm and smaller than 2 mm. The top side of the first comb element (the side of the first comb element facing away from the cutting assembly) is therefore relatively closely arranged to the stationary and the moveable cutting edge, so that the cutting edges are fairly good visible to the user.

According to a further embodiment, a length of the first comb ribs measured along the longitudinal direction is smaller than or equal to 25 mm.

This upper limit for the length of the first comb ribs has been selected, since longer comb ribs have shown to be too flexible and too instable. A length of less than 25 mm instead results in comparatively stiff comb ribs.

According to a further embodiment, the hair clipping device further comprises an adjustment mechanism for adjusting the position of the comb attachment relative to the cutting assembly substantially parallel to the longitudinal direction.

This allows having a single comb attachment on the hair clipping device which is adjustable in length settings depending on the user's needs. The adjustment mechanism preferably allows adjusting the length settings from e.g. 1 mm up to 21 mm. The adjustment mechanism may either be configured to allow a length setting in predefined steps, e.g. steps of 1 mm, or to allow a stepless setting over the whole range of e.g. 1 to 21 mm.

The adjustment mechanism may comprise one or more guiding rails provided on the hair clipper housing which engage with corresponding guiding rails arranged on the comb attachment. Likewise it is also possible to include a ratchet-type guiding rail. According to a preferred embodiment, the adjustment mechanism is configured to adjust the comb attachment between different adjustment positions, wherein the adjustment mechanism is configured to ensure a substantially equal distance of less than 2 mm, preferably of less than 1 mm, between a backside of the first comb ribs and the stationary cutting edge.

In other words, this means that the backside of the first comb ribs have a constant distance of less than 2 mm to the stationary cutting edge independent of the length setting. While changing the length setting, the backside of the first comb ribs constantly has approximately said distance to the stationary cutting edge. This ensures that the first comb element remains in close contact to the cutting assembly over the whole length setting range. A distance of less than 2 mm, preferably of less than 1 mm provides the advantage that cut hairs are effectively prevented from falling out of the system and being spread all around. It shall be noted that the backside of the first comb ribs is meant to denote the side of the first comb ribs that faces towards the cutting assembly during use.

According to a further embodiment, a free end of the first comb ribs comprises a rounded tip portion. Said free end in other words comprises a radius. Such a rounded tip portion especially prevents skin irritations.

According to a further refinement, the comb attachment further comprises a second comb element that is configured to at least partly cover the distal end of the housing, wherein the second comb element comprises a plurality of second comb ribs running parallel to each other and transverse to the first comb ribs of the first comb element, wherein a free end of the first comb ribs is spaced apart from a free end of the second comb ribs, such that a gap occurs between the first and the second comb element.

The comb attachment is according to this refinement therefore not closed in between the first and the second comb element, but comprises a gap which extends in lateral direction preferably parallel to the cutting assembly. The first comb element is thus not directly connected to the second comb element, but separated by a gap. This gap enables to get closer to the skin of the user. This improves the ability of the hairs to reach the cutting edges. The gap thus improves the hair cutting performance.

The gap in between the first and the second comb element furthermore enables a gap size and a pitch size of the second comb element to differ from the gap size and the pitch size of the first comb element. The second comb element may thus have less comb ribs having dimensions which differ from the dimensions of the first comb ribs. The width and the height of the second comb ribs is preferably chosen to be larger than the width and the height of the first comb ribs.

According to a further embodiment, the second comb ribs run parallel to a longitudinal direction of the second comb element, wherein an angle between the longitudinal direction of the first comb element and the longitudinal direction of the second comb element is smaller than 90°, preferably smaller than 80°. It has been shown that an angle of less than 80° between the first comb element and the second comb element ensures that hairs can still be caught effectively and that larger angles would result in a reduction or even loss of the above-mentioned advantageous lifting function of the first comb element.

According to a still further embodiment, the hair clipping device may furthermore comprise a suction unit for generating an under-pressure in an area between the cutting assembly and the comb attachment. Such a suction unit may suck in cut hairs and guide them towards a collection surface or collection container. In combination with the above-mentioned fine-pitched comb structure of the first comb element this even more effectively prevents an unwanted dispersal of cut hairs, i.e. preventing cut hairs from falling out of the system.

### BRIEF DESCRIPTION OF THE DRAWINGS

These and other aspects of the invention will be apparent from and elucidated with reference to the embodiment(s) described hereinafter. In the following drawings

FIG. 1 shows a perspective view of an embodiment of a hair clipping device with a comb attachment according to the present invention;

FIG. 2 shows a perspective view of the embodiment of the hair clipping device shown in FIG. 1 without the comb attachment;

FIG. 3 shows an enlarged view of a front section of the hair clipping device according to the present invention from above;

FIG. 4 shows an enlarged view of the front section of the hair clipping device according to the present invention from below; and

FIG. 5 shows an enlarged side view of the front section of the hair clipping device according to the present invention.

### DETAILED DESCRIPTION OF THE INVENTION

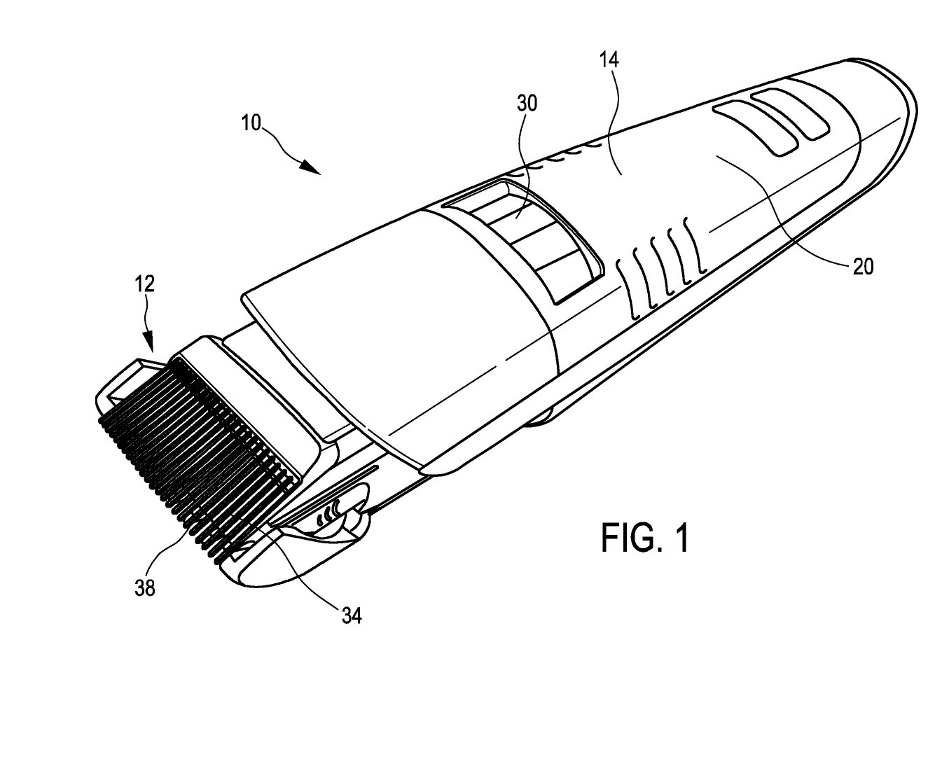

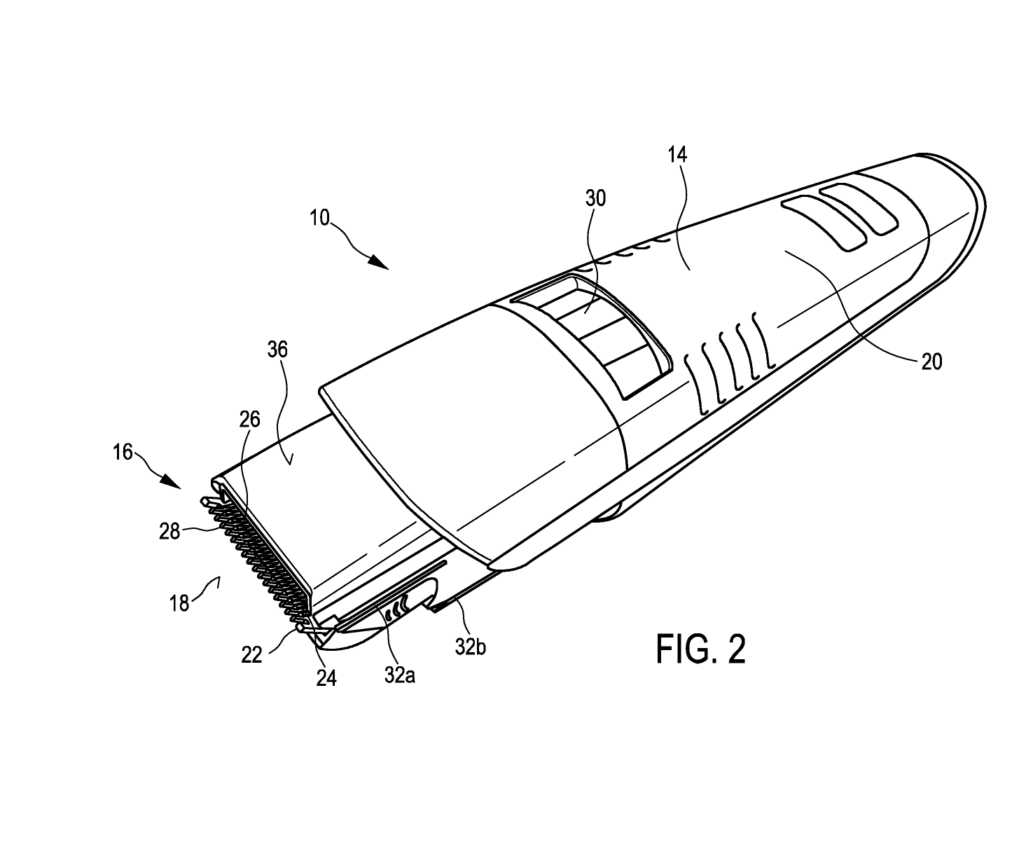

FIGS. 1 and 2 show an embodiment of the hair clipping device according to the present invention with and without a comb attachment. The hair clipping device is therein in its entirety denoted with reference numeral 10.

The hair clipping device 10 comprises a comb attachment 12 which is releasably attachable to the hair clipper 10. FIG. 1 shows the hair clipping device 10 with comb attachment 12, whereas FIG. 2 shows the hair clipping device 10 without the comb attachment 12.

The hair clipping device 10 comprises a housing 14 in which all remaining parts are usually integrated and to which the comb attachment 12 may be attached. The housing 14 also serves as a holder for a cutting assembly 16. The cutting assembly 16 may be releasably fixed to a distal end 18 of the housing 14. The cutting assembly 16 may, however, also be permanently fixed to the distal end 18 of the housing 14. The housing 14 is usually realized as an elongated body that forms a handle 20 at its rear end, i.e. the end opposite the distal end 18.

The cutting assembly 16 comprises a stationary cutting blade 22 and a moveable cutting blade 24. The moveable cutting blade 24 is in the known manner displaceable mounted on an upper surface of the stationary cutting blade 22. By the help of one or more springs (not shown), the moveable cutting blade 24 is resilient biased against the stationary cutting blade 22. This spring exerts a spring force onto the moveable cutting blade 24 in order to keep the two cutting blades 22, 24 close together. Both cutting blades 22, 24 each comprise a cutting edge 26, 28 with a plurality of cutting teeth arranged in parallel to each other. The cutting edge 26 of the stationary cutting blade 22 is herein denoted as stationary cutting edge 26. The cutting edge 28 of the moveable cutting blade 24 is herein denoted as moveable cutting edge 28.

During operation hair cutting is performed by the interaction of the stationary cutting blade 22 and the moveable cutting blade 24 that reciprocates on the stationary cutting blade 22 as this is known from other conventional hair clipping devices.

The stationary cutting blade 22 is usually designed to be thicker than the moveable cutting blade 24. Said stationary cutting blade 22 is also denoted as “guard”. In order to receive a good cutting performance, the moveable cutting blade 24 is actively pressed onto the upper surface of the guard 22 to receive a so-called teeth pressure. This teeth pressure is, inter alia, guaranteed by the above-mentioned spring that presses the two cutting blades 22, 24 together.

A drive arrangement including a motor (not shown) is configured to drive the moveable cutting blade 24 in an oscillatory manner relative to the stationary cutting blade 22. The motor itself is usually realized as an electric motor that is either powered by main supplied electricity or battery-driven.

Depending on the desired hair cut length that shall be achieved, the hair clipping device 10 may either be used with or without comb attachment 12. Especially when longer hair cut lengths are desired, the comb attachment 12 may be attached to the distal end 18 of the housing 14. As shown in FIG. 1, the comb attachment 12 is thereby mounted over the cutting assembly 16 and spaces the cutting blades 22, 24 apart from the surface of the skin of the user from which the hairs extend. It so to say acts as a spacer between the user's skin and the cutting assembly 16, so that the resulting length of the hair cut is increased compared to a usage of the hair clipping device 10 without comb attachment 12.

The comb attachment 12 is preferably designed to be displaceable relative to the housing 14, so that different hair cut lengths may be achieved with one and the same comb attachment 12. The hair clipping device 10 thereto comprises an adjustment mechanism 30 for adjusting the position of the comb attachment 12 relative to the housing 14. The adjustment mechanism 30 comprises according to the embodiment shown in FIGS. 1 and 2 an adjustment wheel that allows shifting the comb attachment 12 by turning the adjustment wheel about a longitudinal axis of the handle 20. However, it shall be noted that the adjustment mechanism 30 may also be differently designed, e.g. comprising a shifting bar or other types of mechanical shifting mechanisms. In the shown embodiment the comb attachment 12 is guided by two guiding rails 32a, b that are arranged on two opposing lateral sides of the housing 14 and two corresponding guiding rails (not shown) arranged on an inner side of the comb attachment 12. Instead of these guiding rails a ratchet-type mechanism may be provided.

It is to be noted that the adjustment mechanism 30 for adjusting the position of the comb attachment 12 relative to the housing 14 may be realized in a variety of other ways. Instead of a stepless adjustment of the comb attachment 12 relative to the housing 14, other adjustment mechanisms are conceivable for providing a stepwise adjustment in certain predefined steps, e.g. in 1 mm steps.

One of the central points of the present invention relates to the structural technical design of the comb attachment 12. The comb attachment 12 comprises a first comb element 34 that is configured to be arranged on a front side 36 of the housing 14 and configured to cover the stationary and the moveable cutting edge 26, 28 when the comb attachment 12 is attached to the housing 14 of the hair clipping device 10. It is to be noted that the front side 36 of the housing 14 shall denote the upper side of the housing 14 which runs transverse to the surface provided at the distal end 18 of the housing 14. The latter mentioned surface at the distal end 18 is arranged at the bottom side of the cutting assembly 16, i.e. at the side of the stationary cutting blade 22 that faces away from the moveable cutting blade 24. In the context of this invention “transverse” shall not necessarily be understood as “perpendicular”. The term “transverse” should be understood as “non-parallel”.

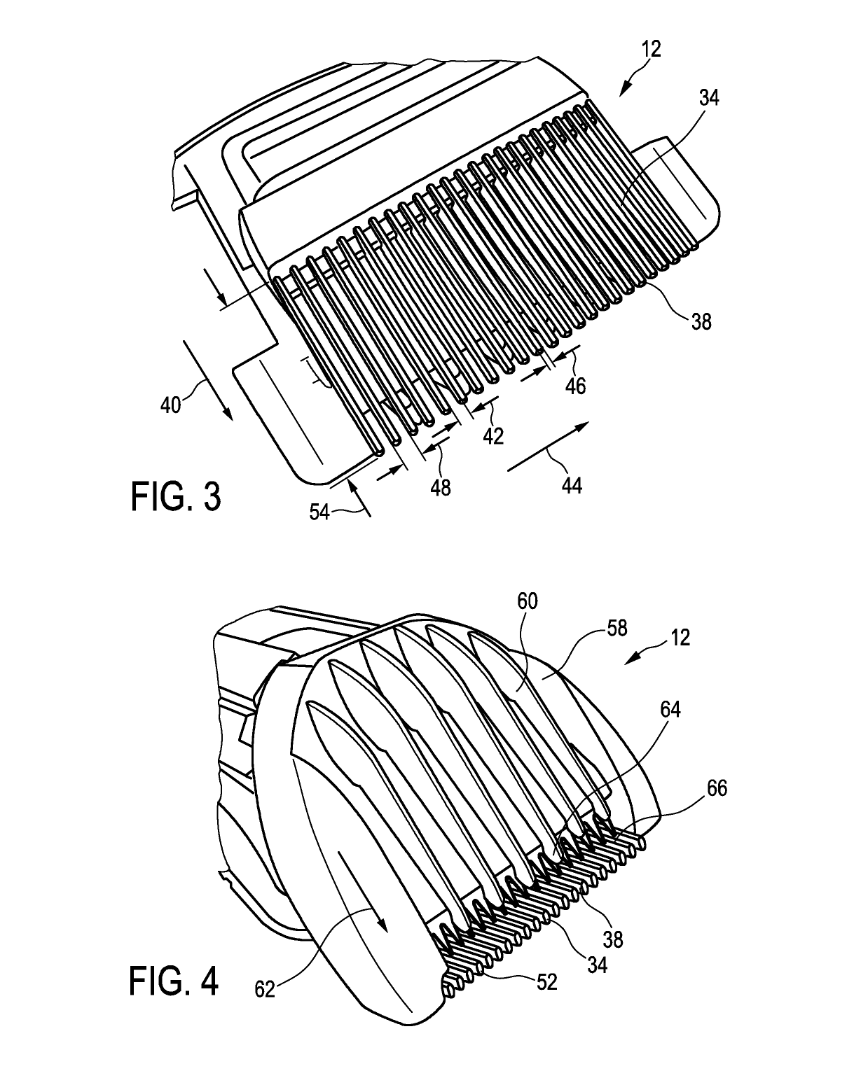

An enlarged view of the first comb element 34 is shown in FIG. 3. The first comb element 34 comprises a plurality of first comb ribs 38. These first comb ribs 38 are arranged in parallel to each other and run parallel to a longitudinal direction 40 of the first comb element 34. All of the first comb ribs 38 preferably have the same dimensions. In contrast to known of comb elements of the prior art, the dimensions of the first comb ribs 38 and the distances between the first comb ribs 38 are chosen to be comparatively small which results in a very fine-pitched comb structure. A distance 42 between two neighboring comb ribs 38 is preferably smaller than 1 mm. Said distance 42 is herein denoted as gap size. The gap size 42 is defined as distance between two neighboring comb ribs 38 measured in lateral direction 44, wherein the lateral direction 44 is arranged perpendicular to the longitudinal direction 40 of the first comb ribs 38. It shall be noted that the mentioned gap size 42 preferably occurs between all neighboring comb ribs 38. A width 46 of each of the first comb ribs 38 is preferably in the range of 0.5 mm and 1 mm. Said width 46 denotes the dimension of each of the first comb ribs 38 measured in the lateral direction 44. A pitch size 48, which is defined as sum of the gap size 42 and the width 46, is preferably smaller than 2 mm.

Such a fine-pitched comb structure of the first comb element 34 increases the probability that curled and stiff hairs are actively caught and lifted. In other words, the first comb element 34 provides an active manipulation also for curled and stiff hairs to lift them up from their natural orientation, such that the hair cutting performance is significantly improved in contrast to “regular” comb attachments of the prior art which usually have significantly larger gap sizes with larger comb ribs.

Due to the comparatively small pitch size 48 the overall number of first comb ribs 38 arranged in parallel to each other is also increased compared to “regular” comb attachments known in the art. Such a comb attachment usually has an overall width of around 20-50 mm. A pitch size of less than 2 mm as herein presented thus results in an overall number of 20 or more first comb ribs 38.

The fine-pitched grating structure furthermore provides the advantage that cut hairs are prevented from flying out of the system and being dispersed all around in the bathroom. In contrast thereto, the cut hairs will be collected in between the first comb element 34 and the housing 14.

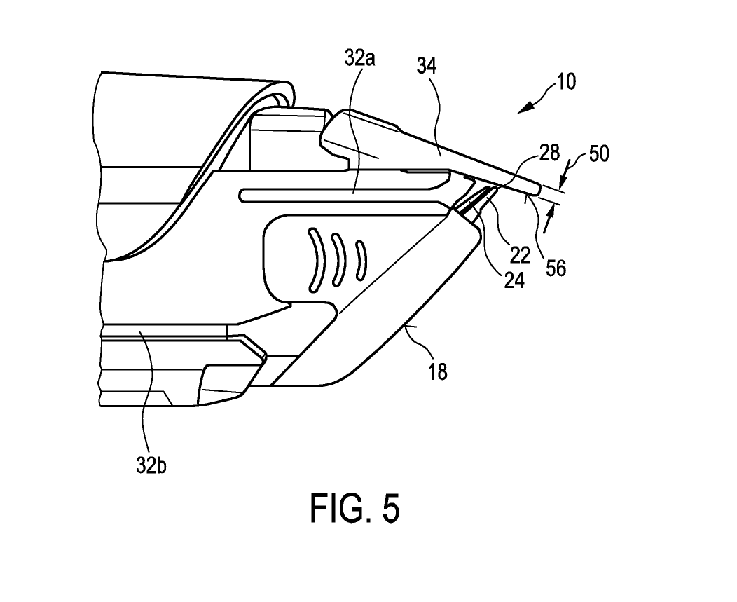

Experiments of the applicant have lead to the following preferred size dimensions. The gap size 42 is preferably chosen to be between 0.2 mm and 0.8 mm. The pitch size 48 is preferably chosen to be between 0.7 mm and 1.7 mm. The width 46 of the first comb ribs 38 is preferably chosen to be between 0.5 mm and 1 mm. A height 50 (see FIG. 5) of the first comb ribs 38 is preferably chosen to be between 1 mm and 2 mm. Said height 50 denotes the dimension of the first comb ribs 38 measured perpendicular to the longitudinal and the lateral direction 40, 44. Such a small height provides the advantage of an increased visibility of the cutting assembly 16, such that the cutting assembly 16, in particular the cutting edges 26, 28, are always clearly visible to the user during use. This facilitates the handling of the hair clipping device 10 for the user.

It shall be noted that even though the first comb ribs 38 are designed to be very thin (having a very small width 46 and height 50), the first comb element 34 has been shown to be quite comfortable for the user, such that no skin irritation occurs. This is especially due to the fact of the comparatively small chosen pitch size 48/gap size 42. The free end or distal end 52 of the first comb ribs 38 in addition preferably comprises a rounded tip portion for further improving the comfort for the user.

A length 54 of the first comb ribs 38 measured along the longitudinal direction 40 is preferably smaller than or equal to 25 mm. Larger lengths 54 would result in too flexible and too weak comb ribs 38.

In order to guarantee the above-mentioned function and advantages of the first comb element 34, the backside of the first comb element which faces the cutting edges 26, 28 during use, should be arranged in close proximity to the cutting edges 26, 28. This should be also ensured for the different length settings. The above-mentioned adjustment mechanism 30 is therefore preferably configured to adjust the comb attachment 12 between different adjustment positions, wherein the adjustment mechanism 30 ensures a substantially equal distance between the backside 56 of the first comb ribs 38 and the stationary cutting edge 28 (see FIG. 5). The latter mentioned distance is preferably smaller than 2 mm, more preferably smaller than 1 mm. Such a close proximity guarantees the above-mentioned function of the first comb element 34, i.e. preventing cut hairs from flying out of the system. This function could even be improved, if the hair clipping device 10 further comprises a suction unit (not shown) for generating an under-pressure in the area between the cutting assembly 16 and the comb attachment 12. Such a suction unit could allow sucking in cut hairs and collecting them in a special compartment within the interior of the housing 14.

Further features of the comb attachment 12 are shown in FIG. 4. FIG. 4 shows the comb attachment 12 from below. According to the therein shown embodiment, the comb attachment 12 further comprises a second comb element 58. This second comb element 58 is arranged transverse to the first comb element 34 and configured to cover the distal end 18 of the hair clipper housing 14, i.e. the bottom side of the cutting assembly 16. The bottom side of the cutting assembly 16 is the side of the stationary cutting blade 22 that faces away from the moveable cutting blade 24. The second comb element 58 comprises a plurality of second comb ribs 60 running parallel to each other. The second comb ribs 60 are preferably arranged parallel to a longitudinal direction 62 of the second comb element 58.

As it can be seen in FIG. 4, the dimensions of the second comb element 58, in particular the gap size, the width, the pitch size and the thickness of the second comb ribs 60, differ from the dimensions of the first comb element 34. The second comb element 58 preferably comprises fewer comb ribs 60 with larger gaps in between them. The comb ribs 60 are also chosen to be thicker and wider than the comb ribs 38 of the first comb element 34.

The free ends 64 of the second comb ribs 60 are spaced apart from the free ends 52 of the first comb ribs 38. The first comb element 34 is therefore not connected to the second comb element 58 at the front section of the comb attachment 12. A gap 66 occurs between the first and the second comb element 34, 58, which gap 66 runs substantially parallel to the lateral direction 44. This gap 66 allows the user to get closer with his/her skin to the cutting edges 26, 28 of the cutting assembly 16, such that a better hair cutting performance is ensured.

The present invention in summary provides a hair clipping device with an improved comb attachment having a fine-pitched grating structure in order to improve hair lifting and prevent cut hairs from flying out of the system.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

Any reference signs in the claims should not be construed as limiting the scope.

1. A hair clipping device comprising:
a housing,
a cutting assembly is arranged on a distal end of said housing and comprises a stationary cutting blade with a stationary cutting edge and a moveable cutting blade with a moveable cutting edge, and
a comb attachment which is attachable to the housing,
wherein the comb attachment comprises a first comb element that is configured to be arranged on a front side of the housing and configured to cover the stationary and the moveable cutting edge, wherein said front side runs transverse to the distal end and the cutting assembly;
wherein the first comb element comprises a plurality of first comb ribs running parallel to each other and parallel to a longitudinal direction of the first comb element, wherein a gap size, which is defined as distance between two of the first comb ribs measured in lateral direction perpendicular to the longitudinal direction, is smaller than 1 mm, and wherein a pitch size, which is defined as a sum of the gap size and a width of one of the first comb ribs measured in the lateral direction, is smaller than 2 mm.

2. The hair clipping device according to claim 1, wherein the gap size is larger than 0.2 mm and smaller than 0.8 mm.

3. The hair clipping device according to claim 1, wherein the pitch size is larger than 0.7 mm and smaller than 1.7 mm.

4. The hair clipping device according to claim 1, wherein the width of the first comb ribs is larger than 0.5 mm and smaller than 1 mm.

5. The hair clipping device according to claim 1, wherein a height of the first comb ribs measured perpendicular to the lateral and the longitudinal direction is larger than 1 mm and smaller than 2 mm.

6. The hair clipping device according to claim 1, wherein a length of the first comb ribs measured along the longitudinal direction is smaller than or equal to 25 mm.

7. The hair clipping device according to claim 1, further comprising an adjustment mechanism for adjusting the position of the comb attachment relative to the cutting assembly substantially parallel to the longitudinal direction.

8. The hair clipping device according to claim 7, wherein the adjustment mechanism is configured to adjust the comb attachment between different adjustment positions, and wherein the adjustment mechanism is configured to ensure a substantially equal distance of less than 2 mm, preferably of less than 1 mm, between a backside of the first comb ribs and the stationary cutting edge.

9. The hair clipping device according to claim 1, wherein a free end of the first comb ribs comprises a rounded tip portion.

10. The hair clipping device according to claim 1, wherein the comb attachment further comprises a second comb element that is configured to at least partly cover the distal end of the housing, wherein the second comb element comprises a plurality of second comb ribs running parallel to each other and transverse to the first comb ribs of the first comb element, wherein a free end of the first comb ribs is spaced apart from a free end of the second comb ribs, such that a gap occurs between the first and the second comb element.

11. The hair clipping device according to claim 10, wherein a gap size and pitch size of the second comb element differs from the gap size and pitch size of the first comb element.

12. The hair clipping device according to claim 10, wherein the second comb ribs run parallel to a longitudinal direction of the second comb element, and wherein an angle between the longitudinal direction of the first comb element and the longitudinal direction of the second comb element is smaller than 90°, preferably smaller than 80°.

13. The hair clipping device according to claim 1, further comprising a suction unit for generating an under-pressure in an area between the cutting assembly and the comb attachment.

14. A comb attachment for attachment to a hair clipping device having a housing, which hair clipping device is, during use, to be moved in a moving direction over a skin for clipping hairs present on said skin with a cutting assembly,
wherein the comb attachment comprises a first comb element, said first comb element comprising a plurality of first comb ribs running parallel to each other and parallel to a longitudinal direction of the first comb element, wherein a gap size, which is defined as distance between two of the first comb ribs measured in lateral direction perpendicular to the longitudinal direction is smaller than 1 mm, and wherein a pitch size, which is defined as a sum of the gap size and a width of one of the first comb ribs measured in the lateral direction, is smaller than 2 mm,
wherein the comb attachment is configured to be arranged to a front side of a housing of the hair clipping device, and
wherein, when the comb attachment is attached to the hair clipping device, the longitudinal direction of the first comb element is arranged to be oriented away from the skin during use and the first comb element is preceding the hair clipper cutting assembly,
wherein the comb attachment further comprises a second comb element, wherein the second comb element is arranged transverse to the first comb element and configured to cover, during use, a distal end of the hair clipper housing,
wherein the second comb element comprises a plurality of second comb ribs running parallel to each other, said second comb ribs are preferably arranged parallel to a longitudinal direction of the second comb element,
wherein the free ends of the second comb ribs are spaced apart from the free ends of the first comb ribs such that a gap occurs between the first and second comb element,
wherein gap runs substantially parallel to the lateral direction.
